(19) United States
(12) Patent Application Publication
(10) Pub. No.: US 2005/0003132 A1
(43) Pub. Date: Jan. 6, 2005

(54) Interlocking unit

(76) Inventors: Johan Henric Robert Blix, Bromma (SE); Tomas Erik Peter Svanholm, Alvsjo (SE); Ingvar Lindh, Bromma (SE)

Correspondence Address: WHITE, REDWAY AND BROWN LLP, 1217 KING STREET, ALEXANDRIA, VA, 22314, US

(21) Appl. No.: 10/791,838

(22) Filed: Mar. 4, 2004

(30) Foreign Application Priority Data
Jul. 3, 2003 (EP) 03445033.8

(51) Int. Cl. B32B 3/00; E04F 13/08

(52) U.S. Cl. 428/57; 52/387

(57) ABSTRACT

The present invention relates to an interlocking unit, comprising one or more tongues and one or more grooves being provided with mechanically integrating locking means, wherein at least a part of said one or more tongues or at least a part of said one or more grooves, or both, is provided a polymer film having a T_{g} of higher than about −15° C. The present invention further relates to a floor covering, a wall covering, a method of producing an interlocking unit and uses thereof.

The present invention relates to an interlocking unit, a floor covering, a wall covering, a method of producing an interlocking unit and use of an interlocking unit.

### BACKGROUND

Floor- and wall panels of the resent years have frequently been provided with snap-together, also called click systems, which include tongue and groove joints. These panels can be assembled with or without using a glue. Assembling the panels without using a glue means that the panels can be reused and re-assembled in another place. A disadvantage of non-glued snap-together systems is that the joints will be flexible and not tight, which may result in gaps between the panels where dirt and water can penetrate. Panels with snap-together systems where the panels are glued together can be glued together at assembling or by using pre-application of glue forming a pre-glued system. The prior art pre-glued systems need activation of the pre-applied glue before or upon assembling, for example by heat or by water to provide a fixed joint. Such pre-glued snap-together systems are disclosed in U.S. Pat. No. 6,421,970, WO 01/94720, WO 01/94721, WO 02/063114 and WO 02/29179.

It is an object of the present invention to provide an interlocking unit, which need no activation step upon assembling. Another object of the present invention is to provide a floor covering or a wall covering assembled of several interlocking units with improved strength properties. A further object is to provide an interlocking unit having long storage life and improved storage properties before said interlocking unit is assembled.

### THE INVENTION

The invention relates to an interlocking unit, comprising one or more tongues and one or more grooves being provided with mechanically integrating locking means, wherein at least a part of said one or more tongues or at least a part of said one or more grooves, or both, is provided a polymer film having a T_{g} (glass transition temperature) of higher than about −15° C.

The invention further relates to a method for producing an interlocking unit of the invention, from an interlocking unit comprising one or more tongues and one or more grooves along opposite sides of a locking unit and at least one groove with mechanically integrated locking means, the method comprising the following steps of: (i) applying to at least a part of said one or more tongues or at least a part of said one or more grooves, or both, one or more polymer dispersions or one or more polymer solutions; and (ii) forming at least one polymer film on at least a part of said one or more tongues or at least a part of said one or more grooves, or both; wherein said formed polymer film have a T_{g} higher than about −15° C.

The interlocking unit suitably comprises a panel which is suitably made of a wood-based material which can be non-laminated or laminated such as veneer parquet, prefabricated parquet, etc. The interlocking unit is suitably provided with coupling parts at least along the edges of two opposite sides of the panel forming an interlocking unit. The coupling parts of a first interlocking unit are co-operating with the coupling parts of a second interlocking unit when assembling the two interlocking units. The coupling parts comprise matching parts, wherein said parts mutually match into each other by means of a tongue and a groove coupling formed from a fixed part of the panel either by being connected in a fixed manner to these panels, or by being formed in one piece herewith. The coupling parts (i.e. tongues and grooves) are provided with integrated mechanically locking means. By mechanically integrated locking means is herein understood that these tongues and grooves are provided with snap-together means. The coupling parts are provided with mechanically integrating locking means, which will lock the position of two or more panels by exertion of a tension force upon each coupling part (i.e. tongue and groove).

The tongue and groove can be made of any suitable material. In one embodiment of the present invention said tongue and groove can be made of a wood based material, and produced with snap-together means including one or more snapping tongues or the like with corresponding co-operating snapping grooves. The tongue and groove can be made of or a waterproof or water-resistant such as a thermoplastic, a thermosetting laminate, or a metal such as aluminium. It is preferred that the tongue and groove are made of a wood-based material, preferably wood, such as hard wood or soft wood, most preferably hard wood. However, the groove and tongue can also be made of another wood-based material such as wood fiber board, chipboard, particle board or a veneer impregnated or coated with waterproofing material such as oil, wax or a thermoplastic or thermosetting substance including but not limited to polymeric resins.

The polymer film is suitably provided in form of strands, which may be provided by applying at least one polymer dispersion or at least one polymer solution, preferably at least one aqueous polymer dispersion, on at least a part of each tongue and/or on at least a part of each groove. At least one of the polymer films has a T_{g} of higher than about −15° C., suitably from about −10 to about 65° C., preferably from about −5 to about 50° C., more preferably from about 0 to about 40° C., and most preferably from about 0 to about 30° C. At least one of the polymer films preferably have a pendulum hardness of at least from about 10 pendulums, suitably from about 10 to about 160 pendulums, preferably from about 20 to about 120 pendulums, and most preferably from 20 to 100 pendulums.

The polymer film can be formed from one or more polymer dispersions or one or more polymer solutions, which are allowed to dry to a moisture content of less than about 6 weight % based on the solid content of the dispersion, preferably less than about 4 weight %, more preferably less than about 2 weight %, and most preferable less than about 1 weight %.

The polymer dispersion or polymer solution useful for forming the.one or more polymer films according to the invention preferably comprises a polymer prepared from one or more ethylenically unsaturated monomers forming homopolymers or copolymers. Examples of suitable ethylenically unsaturated monomers are vinylic monomers, such as vinyl esters, e.g., vinyl acetate, vinyl propionate, vinyl butyrate and comonomers thereof with, e.g., ethylene; alkyl esters of acrylic and methacrylic acid such as methyl acrylate, methyl methacrylate, ethyl acrylate, n-butyl acrylate, etc.; butadiene-styrene and derivatives thereof; such as carboxylated butadiene-styrene; substituted or unsubstituted mono- and dialkyl esters of alpha, beta-unsaturated dicarboxylic acids such as the substituted and unsubstituted mono- and dibutyl, mono- and diethyl maleate esters as well as the corresponding fumarates, itaconates and citronates; alpha beta-unsaturated carboxylic acids such as crotonic, acrylic and methacrylic acids and mixtures thereof. Polymers based on vinyl acetate are preferred. Preferably the polymer is prepared from at least 50 weight % vinyl acetate, based on the total weight of the monomers.

Post-crosslinking groups may be incorporated into the polymer by copolymerising one or more ethylenically unsaturated monomers with at least one monomer comprising at least one post-crosslinking group. Suitable post-crosslinking groups include N-alkylol, N-alkoxymethyl, carboxylate and glycidyl groups.

By post-crosslinking monomer used herein is meant a monomer having a first reactive functional group that renders the monomer copolymerisable with ethylenically unsaturated comonomer(s) and a second functional group that does not enter into the copolymerisation reaction during formation of the polymer, but provides a reactive site on the copolymer that may subsequently be reacted under, for example, acidic conditions, with another reactive site on the copolymer and/or the amino resin to crosslink the copolymer and/or the amino resin. Examples of suitable post-crosslinking monomers are N-alkylol acrylamides, e.g., N-methylol acrylamide, N-ethanol acrylamide, N-propanol acrylamide, N-methylol methacrylamide, N-ethanol methacrylamide, N-propanol methacrylamide, N-methylol maleamide, N-methylol maleamic acid, N-methylol maleamic acid esters; the N-alkylol amides of the vinyl aromatic acids, such as N-methylol-p-vinylbenzamide and the like: also N-(alkoxymethyl) acrylates and methacrylates, where the alkyl group has from 1-8 carbon atoms, such as N-(methoxymethyl) acrylamide, N-(butoxymethyl) acrylamide, N-(methoxymethyl) methacrylamide, N-(butoxymethyl) allyl carbamate and N-(methoxymethyl) allyl carbamate, and mixtures of these monomers with allyl carbamate, acrylamide or methacrylamide: and also triallyl cyanurate.

The amount of the polymer in the polymer dispersion or polymer solution is usually within the range of from about 5 to about 70 weight %, suitable within the range of from about 10 to about 50 weight %, and preferably within the range of from about 15 to about 45 weight %, based on the solids of the polymer dispersion or the polymer solution.

Mixtures of polymers containing post-crosslinking groups and polymers without post-crosslinking groups may also be used according to the invention. For example, the polymer may comprise both polyvinyl acetate without post-crosslinking groups and vinyl acetate based polymer containing post-crosslinking groups.

The polymer dispersion or the polymer solution useful for forming the polymer film according to the invention may also comprise a plasticiser such as alcohols, phthalates and polyesters. Examples of suitable alcohols are glycols i.e. mono glycols, polyglycols, polyethylene glycols, glycerols, sugar alcohols. Examples of suitable phthalates are dibutyl phthalate, diisodecyl phthalate. Example of suitable polyesters can be derived from the reaction of a phthalic acid, with ethylene glycol, di-ethylene glycol or a polyethylene glycol and an aliphatic alcohol. The amount of plasticiser in the polymer dispersion or polymer solution is usually less than about 15 weight % based on the content of dry solids in the dispersion, preferably less than about 12 weight %, suitable within the range of from about 0 to about 10 weight %, preferably within the range of from about 4 to about 9 weight %, based on the content of dry solids in the dispersion.

According to one preferred embodiment of the present invention at least two polymer films can be applied to the interlocking unit, in an embodiment of the invention said two films have the same amounts of plasticiser. In an embodiment of the invention said two polymer films can be formed from different polymer dispersions or different polymer solutions having different amounts of plasticiser i.e. one polymer dispersion or one polymer solution having less amount of plasticiser than the other. Preferably at least one first polymer film is formed from one or more polymer dispersions or from one or more polymer solutions having an amount of plasticiser within the range of from about 0 to about 10 weight %, preferably within the range of from about 0 to about 6 weight % based on the dry solids of the dispersion, and at least a second polymer film is formed from one or more polymer dispersions or one or more polymer solutions having an amount of plasticiser of less than about 15 weight %, preferably less than about 10 weight % based on the dry solids of the dispersion.

The one or more polymer dispersions or the one or more polymer solutions forming the polymer films useful for the invention may also comprise polyvinyl alcohol. Suitably the polyvinyl alcohol used has a degree of hydrolysis >75% and can be present in the film forming dispersion within the range of from about 0.1 to about 20 weight %, preferably within the range of from about 1 to about 15 weight %, and most preferably within the range of from about 3 to about 10 weight %, based on the solids of the polymer dispersion or the polymer solution.

The amount polymer dispersion applied onto the interlocking unit is suitably at least about 0.5 g/m, calculated as applied amount per meter longitudinal length of the tongue or groove, preferably at least about 1 g/m, most preferably at least about 2 g/m.

In an embodiment of the present invention the polymer dispersion or the polymer solution forming the polymer films may comprise one or more surfactants i.e. cationic, anionic, nonionic or amphoteric surfactants instead of polyvinyl alcohols. Examples of suitable surfactants are amines, i.e. primary, secondary and tertiary amines, amine salts, alkyl propylene diamines, imidazolines, quaternary ammoium compounds, amine caboxylates; polysiloxane derivatives such as polysiloxane polyalkylene polyether copolymers, polysiloxane polyether copolymers, ethoxylated fatty acids, ethoxylated fatty alcohols, ethoxylated fatty amines, ethoxylated alkanol amines, sulphonate fatty acids, sulphonate fatty esters, etc.

The polymer dispersion or the polymer solution may also comprise an amino resin, such as urea-formaldehyde-, melamine-urea-formaldehyde-, melamine-formaldehyde-, or melamine-urea-phenol-formaldehyde resin. The amino resin may be present alone or in combination with other polymers. The polymer dispersion or the polymer solution may also comprise an amino resin of the types listed above which is etherified.

The interlocking unit of the invention is suitably used for wall coverings or floor coverings, suitably in ordinary dry rooms. However, by using tight joints and water-resistant or water-proof coatings of the panels the panels can be used also in wet rooms. The surface may then be made of a layer of paint, a thermoplastic foil such as polyethylene, polypropylene or polyvinyl chloride, a paper sheet impregnated with a resin, such as thermosetting or UV-curing resin such as one comprising acrylate and a maleimide, or of a thermosetting laminate.

The interlocking unit according to the invention is particularly suitable for wall- and floor-panels, most preferably floor-panels.

Thus, the present invention further relates to a floor covering comprising two or more interlocking units of the invention.

Also the present invention relates to a wall covering comprising two or more interlocking units of the invention.

Finally, the present invention relates to use of the interlocking unit as a wall covering or a floor covering.

The invention will be further explained in connection with the enclosed figures.

### BRIEF DESCRIPTION OF THE DRAWINGS

FIG. 1 shows schematic a cross section through two adjacent edges of two interlocking units to be assembled.

FIGS. 2 to 9 are schematic representations of two assembled interlocking units showing cross sections of different arrangements snapping webs and snapping grooves on tongues and grooves.

### DETAILED DESCRIPTION OF THE DRAWINGS

The invention is further illustrated by means of the following non-limiting drawings and wherein different types of tongue and groove coupling parts are described.

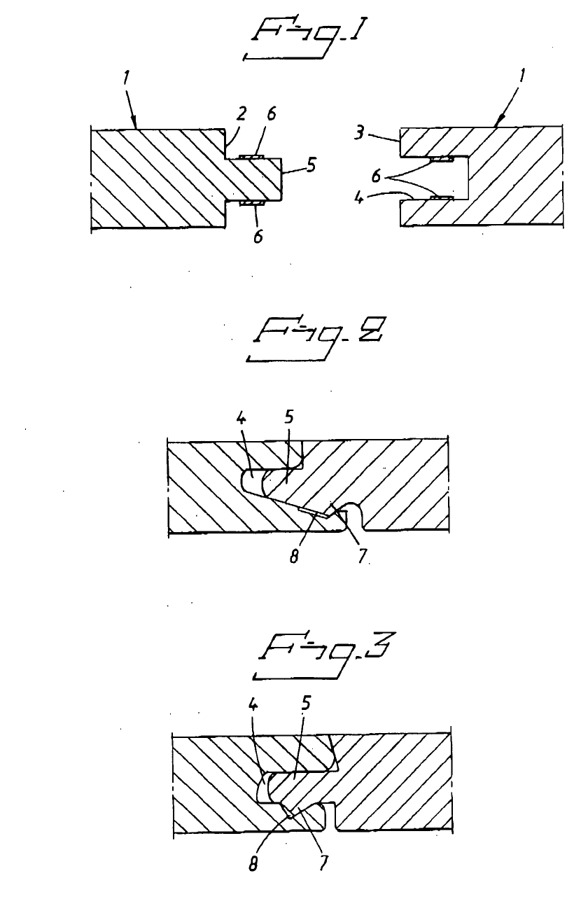

Panel 1 has two parallel side edges 2 and 3, respectively, which are as shown in FIG. 1. The side edges 2 and 3 are provided with mechanical integrated locking means in form of a groove 4, and a tongue 5 fitting in the groove 4, whereby a tongue/groove joint for assembling of the panels is formed. Polymer films 6 are provided on at least a part of each tongue 5 and on at least a part of each groove 4. The mechanically integrated locking means are not shown in FIG. 1.

FIGS. 2 to 5 are showing arrangements where each unit is provided with one tongue 5 and with one groove 4. A snapping web 7 is provided on the tongue 5 either on the upper side or the bottom side of the tongue 5. The corresponding groove 4 is provided with a co-operating fitting snapping groove 8. The polymer films are not shown in any of FIGS. 2 to 5.

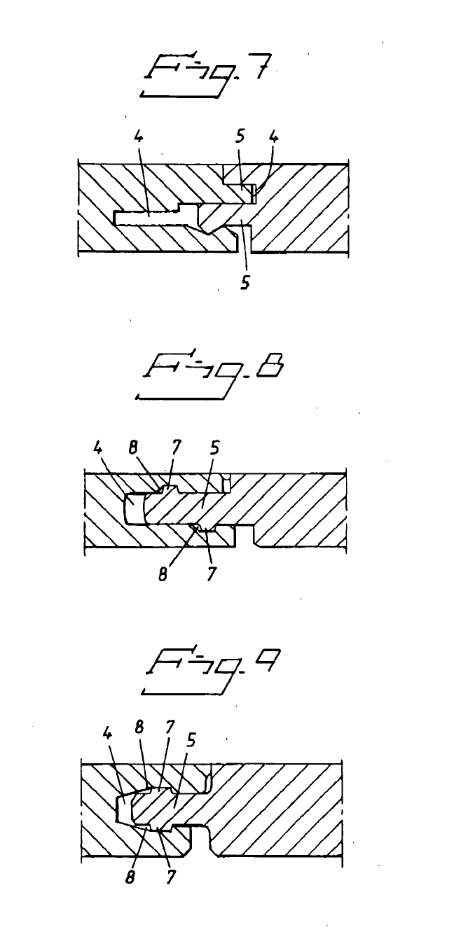

FIGS. 6 and 7 are showing arrangements where each joint comprises at least two tongues 5 and at least two corresponding grooves 4. Each unit edge can either have two tongues 6 or two grooves 4 (FIG. 6) or the unit edges can have one tongue 5 and one groove 4 as can be seen in FIG. 7. The polymer films are not shown in any of FIGS. 6 and 7.

FIGS. 8 and 9 show arrangements of snapping webs 7 on both sides of the tongue 5 and corresponding co-operating fitting snapping grooves 8 on the groove 4. The polymer films are not shown in any of FIGS. 8 and 9.

It is also possible to provide the groove with snapping web and corresponding snapping groove on the tongue.

The invention is further illustrated by means of the following non-limiting examples. Parts and percentages relate to parts by weight and percent by weight respectively, unless otherwise stated.

### EXAMPLES

### Example 1

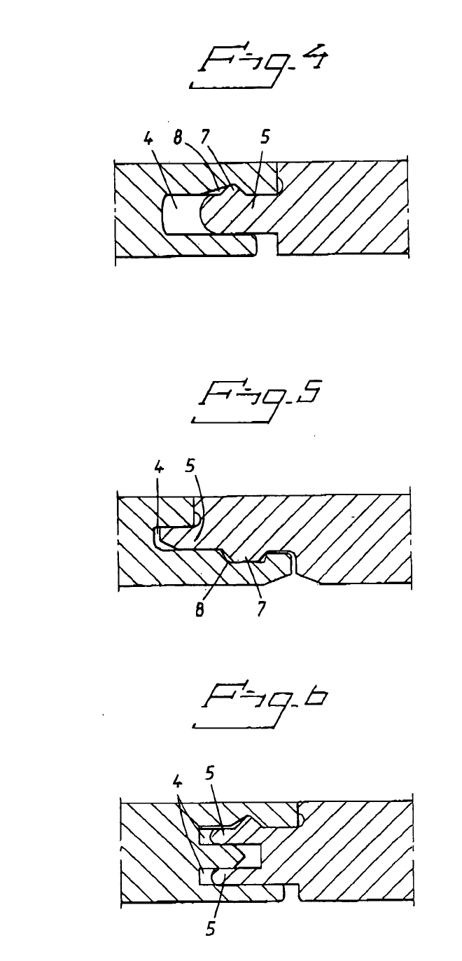

Test pieces made of wood having interlocking units similar to the ones shown in FIG. 4 were tested by applying film-forming dispersions on the tongue and the groove respectively, of the test pieces. In tests Nos. 1 to 4 aqueous dispersions were applied to the test pieces and were allowed to dry at room temperature for three days. The amount dispersion applied was about 4 g/m, calculated as g per lateral meter of the tongue and groove respectively. In test No. 1 (comparative) a dispersion based on polyacrylic ester resulting in a T_{g} of −20° C. of the formed polymer film was applied to the test pieces. In test No. 2 an aqueous dispersion based on polyvinyl acetate together with a suitable amount of butyl diglycol acetate to reach a T_{g} of 13° C. of the formed polymer film was applied to one of the two test pieces. An aqueous dispersion based on polyvinyl acetate together with a suitable amount of butyl diglycol acetate to reach a T_{g} of 17° C. of the formed polymer film was applied to the second test piece. In test No. 3 an aqueous dispersion based on polyvinyl acetate together with a suitable amount of butyl diglycol acetate to reach a T_{g} of 21° C. of the formed polymer film was applied to a first test piece, and an aqueous dispersion of polyvinyl acetate without any plasticiser was applied to the second test piece, the formed polymer film had T_{g} of 39° C. In test No. 4 a urea formaldehyde resin having molecular weight of approximately 500 and aluminium chloride forming a polymer film having a T_{g} of 70° C., was applied to the test pieces. In test No. 5 (comparative) no dispersion was applied to the test pieces.

The test pieces were assembled after the polymer films were formed and after seven days the joints were pulled apart by the use of a mechanical tensile testing machine Alwetron TCT50 programmable mechanical testing facility with climate cabinet (5 ton) from AB Lorentzen & Wettre. The pieces are inserted perpendicular to the direction of the pulling force and the speed of separation is held constant at 2 mm/min. The results are summarised in Table 1 below,

TABLE 1

| | T_{g} of polymer film | T_{g} of polymer film | Strength |
|---|---|---|---|
| Test No. | on first piece | on second piece | [MPa] |
| 1 | −20° C. | −20° C. | 0.3 |
| 2 | 13° C. | 17° C. | 0.9 |
| 3 | 21° C. | 39° C. | 1.2 |
| 4 | 70° C. | 70° C. | 0.4 |
| 5 | — | — | 0.3 |

Surprisingly good strength can be achieved for joints between interlocking units according to the invention.

### Example 2

The aqueous dispersions of test No. 3 in Example 1 were applied to the same type of test pieces as in Example 1. In one test the test pieces were kept at room temperature for 120 days before assembling and in another test the test pieces were kept for 70 days at 80° C. before assembling. After seven days the joints were pulled apart. The results are shown in Table 2.

TABLE 2

| | Strength |
|---|---|
| Storage | [MPa] |
| 120 days in room temperature | 1.1 |
| 70 days at 80° C. | 1.2 |

As seen in Table 2, the storage stability of the test pieces was excellent both at room temperature and at elevated temperature.

1. An interlocking unit, comprising one or more tongues and one or more grooves being provided with mechanically integrating locking means, wherein on at least a part of the one or more tongues or on at least a part of the one or more grooves, or on at least a part of both, is provided a polymer film having a T_{g} of higher than about −15° C.

2. An interlocking unit according to claim 1, wherein at least one of the one or more polymer films has a T_{g} of from about −10 to about 65° C.

3. An interlocking unit according to claim 1, at least one of the one or more polymer films has a T_{g} of from about 0 to about 40° C.

4. An interlocking unit according to claim 1, wherein the polymer films have a moisture content of less than 2 weight % based on the solids content of the polymer film.

5. An interlocking unit according to claim 1, wherein at least one of the one or more polymer films has a pendelum hardness of from about 10 to about 160 pendelums.

6. An interlocking unit according to claim 1, wherein at least one of the one or more polymer films has a pendelum hardness of from about 20 to about 120 pendelums.

7. An interlocking unit according to claim 1, wherein at least one of the one or more polymer films is formed from one or more polymer dispersions or one or more polymer solutions comprising at least one polymer prepared from one or more ethylenically unsaturated monomers.

8. An interlocking unit according to claim 7, wherein at least one of the one or more polymer films is formed from one or more polymer dispersions or one or more polymer solutions comprising polyvinyl acetate.

9. An interlocking unit according to claim 7, wherein the one or more polymer dispersions or the one or more polymer solutions comprise at least one plasticiser.

10. An interlocking unit according to claim 7, wherein the one or more polymer dispersions or the one or more polymer solutions comprise polyvinyl alcohol.

11. An interlocking unit according to claim 7, wherein the one or more polymer dispersions or the one or more polymer solutions comprise one or more surfactants.

12. An interlocking unit according to claim 7, wherein the one or more polymer dispersions or the one or more polymer solutions further comprise an etherified amino resin.

13. An interlocking unit according to claim 7, wherein in at least one first polymer film is formed from one or more dispersions or form one or more polymer solutions having an amount of plasticiser within the range of from about 0 to about 10 weight % based on the dry solids of the dispersion, and at least one second polymer film is formed from one or more dispersions having an amount of plasticiser of less than about 15 weight % based on the dry solids of the dispersion.

14. An interlocking unit according to claim 1, wherein the one or more tongues and the one or more grooves are made of wood-based material.

15. An interlocking unit, comprising one or more tongues and one or more grooves being provided with mechanically integrating locking means, wherein on at least a part of the one or more tongues or on at least a part of the one or more grooves, or on at least a part of both, is provided a polymer film having a T_{g} of from about −10 to about 65° C., and wherein at least one of the one or more polymer films is formed from one or more polymer dispersions or one or more polymer solutions comprising polyvinyl acetate and at least one plasticiser in an amount of less than about 15 weight % based on the content of dry solids in the dispersion.

16. A floor covering comprising two or more interlocking units according to claim 1.

17. A wall covering comprising two or more interlocking units according to claim 1.

18. Method for producing an interlocking unit comprising the steps of:
(i) providing an interlocking unit comprising one or more tongues and one or more grooves along opposite sides of a locking unit and at least one groove with mechanically integrated locking means,
(ii) applying to at least a part of said one or more tongues or at least a part of said one or more grooves, or both, one or more polymer dispersions or one or more polymer solutions; and,
(iii) forming at least one polymer film on at least a part of said one or more tongues or at least a part of said one or more grooves, or both, wherein said formed polymer film has a T_{g} higher than about −15° C.

19. Method according to claim 18, wherein at least one of the one or more polymer films has a T_{g} of from about −10 to about 65° C.

20. Method according to claim 18, wherein the one or more polymer dispersions or the one or more polymer solutions comprise at least one polymer prepared from one or more ethylenically unsaturated monomers, and at least one plasticiser.

21. A floor covering comprising two or more interlocking units according to claim 7.

22. A wall covering comprising two or more interlocking units according to claim 7.
